(19) United States
(12) Patent Application Publication
(10) Pub. No.: US 2006/0016183 A1
(43) Pub. Date: Jan. 26, 2006

(54) Position control system for an adjusting member actuated by a pneumatic actuating drive

(76) Inventor: Heinfried Hoffmann, Frankfurt/Main (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/185,440

(22) Filed: Jul. 19, 2005

(30) Foreign Application Priority Data
Jul. 20, 2004 (DE) 10 2004 035 047.7

(51) Int. Cl. F16D 31/02

(52) U.S. Cl. 60/407

(57) ABSTRACT

A position control system for an adjusting member actuated by a pneumatic actuating drive, such as a pivot drive, comprising a sensor for detecting a position of the adjusting member, at least one signal processing device, such as a set value/actual value comparator or the like, connected to the sensor, and a pneumatic output, such as a current/pressure converter, including a pneumatic amplifier for control of the actuating drive, having the at least one signal processing device and the pneumatic output housed in a common regulator casing. The control casing may be adapted to be flange-connected in the area of a pneumatic interface of the regulating drive housing, while a pneumatic, preferably pipeless, connection is established between the regulator casing and the actuating drive housing, and for the sensor to be disposed outside of the regulator casing.

### FIELD OF THE INVENTION

The instant invention relates to a position control system for an adjusting member, like a control valve, actuated by a pneumatic actuating drive, for example, for a valve adjusted by a pivot drive.

### BACKGROUND OF THE INVENTION

Position control systems are designed to regulate or control the fluid flow rate through a pipeline by way of setting an adjusting member or, at least, to monitor it so as to see, for instance, whether a closing position of the adjusting member of the pipeline indeed has been reached. A sensor included in the position control system detects the position of the adjusting member and sends an actual position signal to a set value/actual value comparator. A control signal is generated on the basis of the comparison between the set and actual values and applied to a pneumatic output means which comprises a current/pressure converter and, preferably, a pneumatic amplifier for emitting a pressure control signal based on which the actuating drive is controlled.

A position control system of this kind is known from VDI/VDE (Verein Deutscher Ingenieure/Verband der Elektrotechnik) guideline 3845, to be looked up in the VDI/VDE Handbuch Regelungstechnik (textbook on control technique) published May 2003. A pneumatic pivot drive is coupled by means of a so-called Namur-Console to the body of a control valve of which the position is adjusted by the position control system. A rocking drive shaft of the pivot drive extends out of the housing of the pivot drive, through the Namur-Console, and towards the control valve. This drive shaft is connected by way of a torque transmitting coupling, such as a Sattel-Reiter coupling, to a driven shaft of the control valve, the latter shaft extending through the control valve housing towards the final control element and causing the latter to open or close.

The known position control system comprises a separate casing for a position regulator and this casing is mounted by means of a bracket on a side surface of the pivot drive housing remote from the control valve. Not only are the signal processing device and a pneumatic output means, including a current/pressure converter and a pneumatic amplifier, received in the position regulator casing, but also a sensor for indirectly detecting the position of the control valve via the position of a drive shaft extension of the pivot drive, which extension passes through the actuating drive housing. The sensor, aligned with the drive shaft, enters into mechanical engagement with the drive shaft extension so as to transmit the detected motion into the position regulator casing for further processing. Upon comparison of the set values and actual values, the output means, being connected to a constant pressure-gas source, effects pneumatic control of the pivot drive, thereby moving the control valve into the desired position.

A standardized drilling pattern, including two pneumatic inlet connections for two working chambers of the pivot drive, is provided in a lateral area of the pivot drive housing. The inlet connections communicate through two pipelines with the pneumatic amplifying output means which is disposed in the position regulator casing and adapted to supply modulated gas pressure or an emergency gas pressure to the pivot drive.

It was found that the effort of manufacture and assembly of this known position control system, approved in practice, are very high. A separate fastening bracket to be mounted on the actuating drive housing is required for installing the position regulator casing. Moreover, pipings are needed with the known position control system in order to establish a pneumatic connection between the output means of the position regulator and the standardized pneumatic connections. In other words, not only are a great number of components required, but, also, additional, difficult assembling steps must be taken. As pipe transitions are susceptible to leakage, the position control system poses a considerable safety risk that can be contained only by costly maintenance.

Furthermore, control errors, as well as positional errors, can occur with the known position control system when the torque transmission coupling between the drive shaft and the driven shaft begins to wear or even fails entirely. These occurrences cannot be detected by the known sensor arrangement which detects the position of the control valve mechanically and indirectly via the drive shaft of the actuating drive.

It is desirable to overcome the disadvantages of the known position control system, especially by providing a position control system for an adjusting member, like a control valve, adjusted by a pneumatic actuating drive, such as a pivot drive, the position control system assuring reliable control of the position of the adjusting member, at low cost involved in the assembly and maintenance of the position control system. This need is met by the features described and claimed herein.

### BRIEF DESCRIPTION OF THE DRAWINGS

Various features, properties, and advantages of the invention will become apparent from the description below, with reference to the accompanying drawings, in which:

FIG. 1 is a diagrammatic side elevation of a position control system according to an embodiment of the invention installed in an arrangement of a pneumatic actuating drive and adjusting member;

FIG. 2 is a top plan view of a drilling pattern standardized according to VDI/VDE guideline 3845, for an assembling connection and a pneumatic connection; and

FIG. 3 is a block diagram of an embodiment of the position control system according to an embodiment of the invention.

### DETAILED DESCRIPTION OF THE PREFERRED EMBODIMENT

A position control system is provided herein for an adjusting member actuated by a pneumatic actuating drive, such as a pivot drive, wherein a signal processing device and a pneumatic output are housed in a common regulator casing. In one embodiment, the common regulator casing is adapted to be flange-connected in the area of a pneumatic interface of the actuating drive housing, while, at the same time, a pneumatic connection is established between the regulator casing and the actuating drive housing. The sensor is arranged outside of the regulator casing. The pneumatic connection may be implemented without the use of pipelines, for instance, by utilizing the flange connecting forces to squeeze sealing rings between the control casing and the actuating drive housing.

Mounting and maintenance costs can clearly be reduced because both the regulator casing and the actuating drive housing simply need to be provided with fastening or flanging locations near the given pneumatic connections, whereas fastening yokes or brackets can be dispensed with. Advantageously, embodiments of the invention permit given fastening locations, even standardized ones to be utilized, such as standardized threaded bores in the area of the pneumatic inlet connections into the actuating drive housing.

Moreover, according to aspects of the invention, the sensor can be disposed outside of the regulator casing. Such embodiments of the invention overcome a prejudice that the sensor must be located near the position regulator so as to obtain short signal transmission distances to the signal processing device and that, of course, the sensor must be arranged near the easily accessible side of the actuating drive housing from which the drive shaft extension protrudes so as to guarantee aligned access to the drive shaft. Flanging the regulator casing at the pneumatic interface of the actuating drive housing, surprisingly, has proven to be highly advantageous in that, on the one hand, the assembly of the position control system becomes much easier and, on the other hand, greater reliability is achieved in operation in spite of the additional structural expenditure involved in having to transmit the signal from the sensor for signal processing because of the separation of the sensor from the control casing.

With the position control system according to the invention, furthermore, the regulator casing no longer need be formed with leak-prone passages for transmission of the detected drive shaft movements into the regulator casing. Unexpectedly, it was also found that the measures according to the invention are applicable to advantage not only with a pivot drive embodiment but also with a so-called reciprocating drive which, for example, causes translatory movements of a valve rod by a diaphragm.

The pneumatic communication established by the flange connection between the regulator casing and the actuating drive housing, without resorting to any piping, specifically avoids the risk of leakage and reduces the mounting and maintenance expenditure of the position control system. In addition, the optimum sensor location can be selected for the sensor to determine the position of the adjusting member. Hereby, false measurements are practically excluded, which might occur, for instance, due to wear or even breakage of the coupling between the drive shaft and the driven shaft or due to elastic deformation of the latter.

In one exemplary embodiment, the signal processing comprises a set value/actual value comparator. The pneumatic output may comprise a current/pressure converter to convert the control signal supplied from the signal processing into a pneumatic signal to be applied to a pneumatic amplifier which likewise may be associated with the pneumatic output. The pneumatic amplifier, especially, may be embodied by a pneumatically adjustable valve that is set in response to the pneumatic control signal. Coupling a pneumatic amplifier to a source of constant gas pressure which provides a constant operating gas pressure of about 6 bar, for instance, will amplify the pneumatic control signal so that the desired actuating drive force is obtained. The set value/actual value comparator, the current/pressure converter, and/or the pneumatic amplifier can be housed in the common regulator casing.

In a particular embodiment, a drilling pattern of the regulator casing for making the pneumatic connection is adapted to the drilling pattern of the interface, the latter pattern in particular corresponding to the standardized drilling pattern of VDI/VDE (Verein Deutscher Ingenieure/Verband der Elektrotechnik) guideline 3845. An advantage of this particular embodiment is that, for most actuating drive means that are in compliance with standards, it provides a position control system ready for use and easy to install without having to make any substantial changes in the construction of the drive. The drilling pattern of VDI/VDE (Verein Deutscher Ingenieure/Verband der Elektrotechnik) guideline 3845 comprises not only two connections for pneumatic supply but also four bores for attachment which are suitable for flanging the regulator casing to the actuating drive housing. The drilling pattern of the regulator casing, preferably, is a mirror image of the drilling pattern according to guideline 3845.

The regulator casing of a further embodiment of the invention comprises at least one pneumatic inlet connection for establishing pneumatic communication with a pressure-gas source. Gas at modulated pressure can be introduced through this inlet to power the actuating drive. With this further embodiment, an inlet connection from the pressure-gas source at the actuating drive housing is not required. An actuating drive that includes several working chambers may be furnished with several pneumatic outlet connections at the regulator casing.

In a particular embodiment, the regulator casing may include a pneumatic inlet connection through which the pneumatic output comprised of the current/pressure converter is supplied with energy. The regulator casing further includes a pneumatic inlet connection at a side surface of the regulator casing facing the interface. The regulator casing is free of a pneumatic inlet connection for direct pneumatic communication with a pressure-gas source. In a particular subcategory of this embodiment, the pneumatic amplifier is arranged in the actuating drive housing rather than the regulator casing, while the signal processing and the current/pressure converter are located in the regulator casing. With this embodiment, the regulator casing need not fulfill strict sealing requirements since it is not exposed to the gas pressure of the pressure gas source.

Moreover, at least two pneumatic connections at the regulator casing may be located with respect to each other in such a way that they can be disposed in alignment with at least two pneumatic connections of the actuating drive. The pneumatic connection or connections of the regulator casing preferably is/are provided at a side of the regulator casing facing the interface of the actuating drive housing.

Preferably, the regulator casing includes a flange area of a shape complementary to the actuating drive housing in the area of the pneumatic interface. In this way, assembly is facilitated since the sides facing each other of the regulator casing and the actuating drive housing can be arranged to abut each other so that the pneumatic connection between them can be obtained simply by sealing rings that are pressed together in fluid-tight engagement with the respective pneumatic passage by the application of flanging forces to join the regulator casing and the actuating drive housing.

In a particular embodiment of the invention, the sensor may be disposed next to the adjusting member, preferably being mounted on the outer side of the adjusting member facing the actuating drive. Thus the sensor can directly detect the position of the adjusting member without the need for expensive signal communication means through the adjusting member housing. In addition, the placement of the sensor permits direct detection of the force coupling location between the actuating drive and the adjusting member becoming loose.

Communication between the sensor and the position regulator may be effected electrically, for example, but also pneumatically through a corresponding conduit which leads to the regulator casing.

In another embodiment of the invention, the control may be designed such that modulated gas pressure may be fed to the actuating drive so that the adjusting member can adopt at least one position between the opening and closing positions and remain in this intermediate position. In a preferred embodiment, the adjusting member, particularly the final control element of the control valve, is movable continuously or stepwise into at least two or more intermediate positions where it can be fixed.

The invention, furthermore, relates to a pneumatic actuating drive, comprising an actuating drive housing and a position control system according to the invention. The actuating drive housing in this case may comprise a pneumatic inlet connection that is devised to communicate with a pressure-gas source and is connected through a pneumatic outlet connection of the drive housing to a pneumatic inlet connection of the regulator casing for supply to the pneumatic output.

In a preferred embodiment, a ring-like or sleeve-like member, such as a sealing ring, for instance, an elastomer sealing ring or sealing sleeve is arranged or squeezed between the actuating drive housing in the area of the interface and a flange section of the regulator casing facing the actuating drive housing to establish pneumatic communication between mutually opposed passages in the regulator casing and the actuating drive housing.

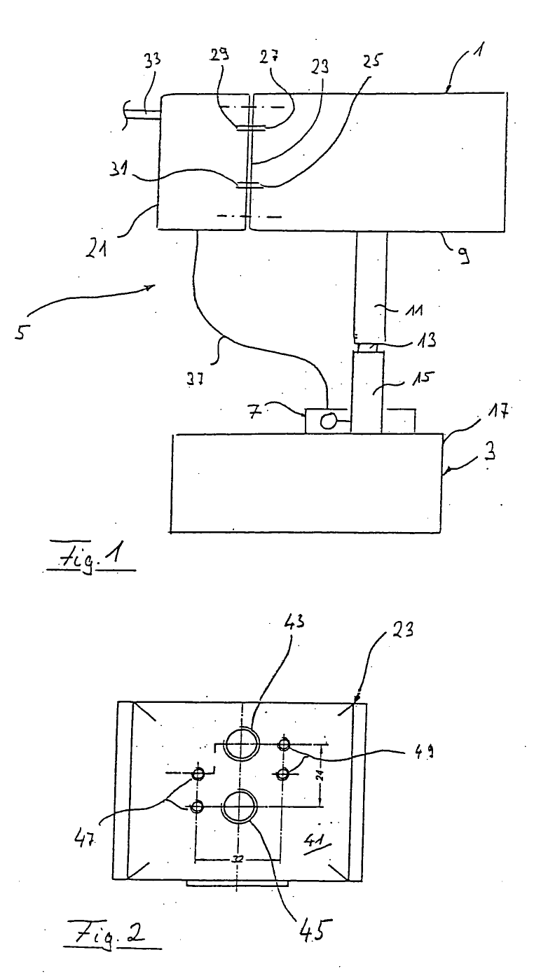

Turning now to the particular embodiments shown in the drawings, FIG. 1 is a diagrammatic side elevation showing a position control system 5 installed in an arrangement consisting of a pneumatic pivot drive 1 and a control valve 3 mechanically coupled to the drive. The system comprises a sensor 7, electronics for set value/actual value comparison, and a pneumatic control or output (not shown), including a current/pressure converter and a pneumatic amplifier.

The pivot drive 1 comprises a drive shaft 11 exiting from the bottom of the pivot drive housing 9 and being connected to the driven shaft 15 of the control valve 3 through the intermediary of a torque transmission mechanism 13, merely indicated diagrammatically and embodied by a Sattel-Reiter coupling, if desired. The driven shaft 15 is adapted to move a final control element (not shown) of the control valve 3 into an open or closed position.

In the illustrated embodiment, the sensor 7 is arranged at the outside of the control valve housing 17. It senses the position of the drive shaft 15 in a freely accessible portion of the drive shaft 15 directly in front of its entry into the control valve housing 17. In this manner, false measurements are avoided that might otherwise be caused by clearance at the torque transmission mechanism 13 and also by elastic torsional deformation of the shafts 11 and 15.

In accordance with principles of the invention, a common regulator casing 21 is provided for both the pneumatic output, not specifically shown, and the signal transmission which consists of at least one signal transmitting device. In one particular embodiment, the regulator casing 21 is flange-connected to a pneumatic interface 23 of the pivot drive housing 9 by means of screws (not shown). The pivot drive housing 9 is formed with two inlet connection bores 25, 27 for two working chambers (not shown) of the pivot drive 1. The regulator casing 21 is formed with outlet connections 29 and 31 in mirror image configuration with respect to the inlet connection bores 25 and 27. An inlet connection 33 of the regulator casing 21 is connected to a constant pressure-gas source (not shown) designed to supply a constant gas pressure, for example, of approximately 6 bar.

The output means determines the gas pressure that is to reach the pneumatic pivot drive 1 through the inlet connection bores 25, 27. A certain position of the drive shaft 11, and thus of the final control element of the control valve 3, are associated with each gas pressure admitted into the pivot drive 1. That allows the final control element (not shown) of the control valve 3 to be moved into any desired intermediate position between the opening and closing positions.

The electrical signal transmission (not shown) is effected by means of an electric lead 37 to the sensor 7. A control signal for producing the desired pressure in the pneumatic pivot drive thus can be generated by electronics (not shown) which execute comparison calculations of set position values and actual position values.

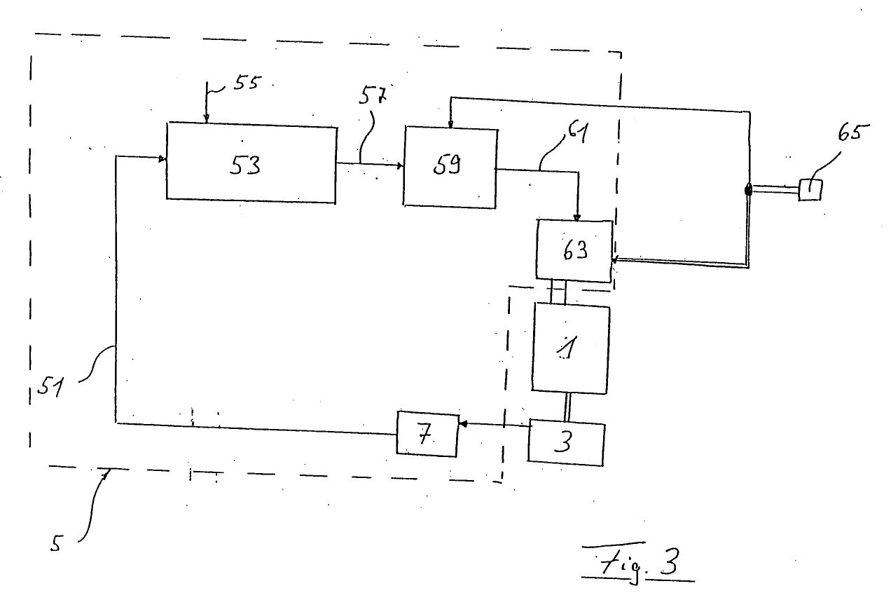

FIG. 2 is a more detailed view of the interface 23, indicated only diagrammatically in FIG. 1, corresponding to the drilling pattern of the above mentioned VDI/VDE guideline 3845. The interface 23 includes a planar flange surface 41 provided substantially in the middle with pneumatic connecting bores 43, 45 and fastening bores 47, 49.

There is an inlet bore 43 and an outlet bore 45 which are formed substantially above each other along a line extending substantially parallel to the axis of the shafts 11 and 15. Fastening bore pairs 47, 49 are formed laterally offset from the former bores, in parallel with respect to the line on which the inlet and outlet bores 43, 45 are located, and above each other. In this particular embodiment, provided for example only, the vertical spacing between the inlet bore 43 and the outlet bore 45 is approximately 24 mm. The horizontal spacing between the bore pairs 47 and 49 is approximately 32 mm.

FIG. 3 is a block diagram showing an embodiment of the position control system 5 in assembly with an arrangement composed of a pneumatic pivot drive 1 and a control valve 3. The sensor 7 detects the position of the control valve 3 by sensing the position of the driven shaft thereof. The sensor 7 applies the actual position signal 51 detected to electronics 53 where the signal 51 of the actual position is compared with a set position value 55. The electronics 53 generates a control signal 57 which is applied to a current/pressure converter 59. The current/pressure converter 59 passes a pneumatic control signal 61 on to a pneumatic amplifier 63 which may be embodied by a valve. The valve is adapted to open or block, either continuously or stepwise, a passage leading from a constant pressure (6 bar) gas source 65 to the pneumatic pivot drive for operating the same.

According to an embodiment of the invention, the electronics 53, the current/pressure converter 59, and preferably the pneumatic amplifier 63 are housed in the regulator casing 21 which is flange-connected to the pivot drive housing 9, establishing a pneumatic connection with the same.

The features of the invention disclosed in the specification above, in the drawings and claims may be used to implement the invention in its various embodiments, both individually and in any combination. It will be appreciated that various changes can be made therein without department from the spirit and scope of the invention.

The embodiments of the invention in which an exclusive property or privilege is claimed are defined as follows:

1. A position control system for an adjusting member actuated by a pneumatic actuating drive in an actuating drive housing, the position control system comprising:
a sensor for detecting a position of the adjusting member;
at least one signal processing device in communication with the sensor; and
a pneumatic output for control of the actuating drive, wherein the at least one signal processing device and the pneumatic output are housed in a common regulator casing,
wherein the regulator casing is adapted to be flange-connected in the area of a pneumatic interface of the actuating drive housing, while a pneumatic connection is established between the regulator casing and the actuating drive housing, and wherein the sensor is disposed outside of the regulator casing.

2. The position control system as claimed in claim 1, wherein the adjusting member is a control valve.

3. The position control system as claimed in claim 1, wherein a drilling pattern of the regulator casing for establishing the pneumatic connection is adapted according to a standardized drilling pattern of the pneumatic interface corresponding in particular to a drilling pattern of VDI/VDE (Verein Deutscher Ingenieure/Verband der Elektrotechnik) guideline 3845.

4. The position control system as claimed in claim 1, wherein the regulator casing comprises at least one pneumatic inlet connection for pneumatic communication with a pressure-gas source and further comprises at least one pneumatic outlet connection through which gas at modulated pressure can be introduced to actuate the actuating drive.

5. The position control system as claimed in claim 1, wherein the regulator casing comprises a pneumatic inlet connection through which the pneumatic output is supplied with energy, and further comprises a pneumatic outlet connection, the regulator casing being free of a pneumatic inlet connection for pneumatic communication with a pressure-gas source.

6. The position control system as claimed in claim 1, wherein at least two pneumatic connections at the regulator casing are disposed with respect to each other such that they can be aligned with at least two pneumatic connections of the actuating drive.

7. The position control system as claimed in claim 1, wherein the regulator casing comprises a flange area of which the shape is complementary to the actuating drive housing in the area of the pneumatic interface.

8. The position control system as claimed in claim 1, wherein the sensor is mounted adjacent the adjusting member.

9. The position control system as claimed in claim 8, wherein the sensor is mounted at the outer side of the adjusting member facing the actuating drive.

10. The position control system as claimed in claim 1, wherein the pneumatic output is configured to supply the actuating drive with gas pressure that is adapted to be modulated so that the adjusting member may be positioned and fixed in at least one intermediate position between opening and closing positions.

11. The position control system as claimed in claim 10, wherein the adjusting member is movable continuously into a plurality of intermediate positions and fixed.

12. The position control system as claimed in claim 10, wherein the adjusting member is movable stepwise into a plurality of intermediate positions and fixed.

13. A pneumatic actuating drive, comprising:
an actuating drive housing; and
a position control system for an adjusting member actuated by the pneumatic actuating drive, the position control system including:
a sensor for detecting a position of the adjusting member;
at least one signal processing device in communication with the sensor; and
a pneumatic output for control of the actuating drive, wherein the at least one signal processing device and the pneumatic output are housed in a common regulator casing,
wherein the regulator casing is adapted to be flange-connected in the area of a pneumatic interface of the actuating drive housing, while a pneumatic connection is established between the regulator casing and the actuating drive housing, and wherein the sensor is disposed outside of the regulator casing.

14. The actuating drive as claimed in claim 13, wherein the actuating drive housing comprises a pneumatic inlet connection to be connected to a pressure-gas source and communicate through a pneumatic outlet connection of the actuating drive housing with a pneumatic inlet connection of the regulator casing for supply to the pneumatic output.

15. The actuating drive as claimed in claim 14, wherein a ring-like or sleeve-like member is arranged between the actuating drive housing in the area of the pneumatic interface and a flange section of the regulator casing facing the actuating drive housing to establish pneumatic communication between mutually opposed pneumatic passages in the regulator casing and the actuating drive housing.

16. The actuating drive as claimed in claim 13, wherein at least two pneumatic connections of the actuating drive are disposed with respect to each other such that they can be aligned with at least two pneumatic connections at the regulator casing.

17. The actuating drive as claimed in claim 13, wherein the actuating drive housing comprises a flange area of which the shape is complementary to the regulator casing in the area of the pneumatic interface.

18. The actuating drive as claimed in claim 13, wherein the pneumatic output is configured to supply a modulated gas pressure to cause the adjusting member to be positioned and fixed in at least one intermediate position between opening and closing positions.

19. The actuating drive as claimed in claim 18, wherein the pneumatic output is configured to cause the adjusting member to move continuously and fix into a plurality of intermediate positions.

20. The actuating drive as claimed in claim 18, wherein the pneumatic output is configured to cause the adjusting member to move stepwise and fix into a plurality of intermediate positions.
